(19) United States
(12) Patent Application Publication
(10) Pub. No.: US 2026/0321237 A1
(43) Pub. Date: Oct. 15, 2026

(54) CONTROL DEVICE AND CONTROL PROGRAM FOR GLASS DIAPHRAGM

(71) Applicant: AGC Inc., Tokyo (JP)

(72) Inventor: Kento SAKURAI, Tokyo (JP)

(73) Assignee: AGC Inc., Tokyo (JP)

(21) Appl. No.: 19/462,971

(22) Filed: Jan. 28, 2026

Related U.S. Application Data
(63) Continuation of application No. PCT/JP2024/025430, filed on Jul. 16, 2024.

(30) Foreign Application Priority Data
Aug. 1, 2023 (JP) 2023-125757

(51) Int. Cl. G10K 11/175; H04R 7/02

(52) U.S. Cl. CPC G10K 11/1752; H04R 7/02; H04R 2499/13

(57) ABSTRACT

A control device for a glass diaphragm including an acquisition unit that is configured to acquire noise related information related to noise flowing into a cabin interior of a vehicle, and a control unit that is configured to perform control to generate overlaying sound to be overlaid with the noise from a glass diaphragm of the vehicle based on the noise related information.

### CROSS-REFERENCE TO RELATED APPLICATIONS

This application is a continuation application of International Application No. PCT/JP 2024/025430, filed Jul. 16, 2024, the disclosure of which is incorporated herein by reference in its entirety. Further, this application claims priority under 35 USC 119 from Japanese Patent Application No. 2023-125757 filed Aug. 1, 2023, the disclosure of which is incorporated by reference herein.

### FIELD

The present disclosure relates to a control device and control program for a glass diaphragm.

### BACKGROUND

Technology has recently been attracting interest in which sound is generated from a glass diaphragm by vibrating the glass diaphragm. For example, Japanese Patent Application Laid-Open (JP-A) No. 2021-180486 discloses technology in which one or more audio generation devices are arranged on a vehicle glass window, and sound is generated from the vehicle glass window by vibration of the audio generation device.

### SUMMARY OF INVENTION

### Technical Problem

However, although technology hitherto has researched the structural content of a glass diaphragm that generates sound from the glass diaphragm, improving the comfort of a cabin interior in a moving body has not been researched.

An object of the present disclosure is to provide a control device and control program for a glass diaphragm capable of improving the comfort of a cabin interior in a moving body.

### Solution to Problem

A first aspect of the present disclosure is a control device for a glass diaphragm including an acquisition unit that is configured to acquire noise related information related to noise flowing into a cabin interior of a moving body, and a control unit that is configured to perform control to generate overlaying sound to be overlaid with the noise from a glass diaphragm of the moving body based on the noise related information.

A second aspect of the present disclosure is a control program that causes a computer to execute processing including acquiring noise related information related to noise flowing into a cabin interior of a moving body, and performing control to generate overlaying sound to be overlaid with the noise from a glass diaphragm of the moving body based on the noise related information.

The present disclosure provides a control device and control program for a glass diaphragm that are capable of improving comfort of a cabin interior of a moving body.

### BRIEF DESCRIPTION OF DRAWINGS

FIG. 1 is a cross-section illustrating an example of a glass diaphragm.

FIG. 2 is a plan view illustrating an example of a vehicle serving is an application target of a glass diaphragm.

FIG. 3 is a diagram illustrating an example of noise flowing into a cabin interior from outside a vehicle.

FIG. 4 is a diagram illustrating an example of an equivalent loudness curves.

FIG. 5 is a block diagram illustrating an example of a control system including a control device for a glass diaphragm.

FIG. 6 is a block diagram illustrating an example of a control device for a glass diaphragm.

FIG. 7 is a flowchart illustrating an example of a flow of control processing executed by a control device for a glass diaphragm.

FIG. 8 is a block diagram illustrating a first modified example of a control system.

FIG. 9 is a block diagram illustrating a second modified example of a control system.

FIG. 10 is a block diagram illustrating a third modified example of a control system.

FIG. 11 is a flowchart illustrating a modified example of a flow of control processing.

### DESCRIPTION OF EMBODIMENTS

Explanation follows regarding an example of a control device and control program for a glass diaphragm according to an exemplary embodiment of the present disclosure, with reference to the drawings.

### Glass Diaphragm Configuration

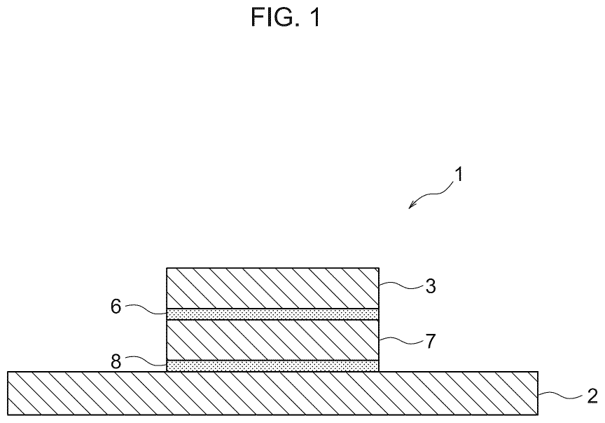

Firstly, prior to describing a control device and a control program for a glass diaphragm according to the present exemplary embodiment, a configuration of a glass diaphragm capable of generating sound will be described. As illustrated in FIG. 1, a glass diaphragm 1 according to the present exemplary embodiment includes a glass plate 2, a exciter 3, a connection member 6, a mounting member 7, and a resin layer 8.

The glass plate 2 may be configured from a single sheet of glass, and may be configured by laminated glass. Laminated glass may be configured including three or more glass plates. Moreover, the glass plate 2 may be formed from an inorganic glass and may be formed from an organic glass. Examples of an organic glass include, for example, a polymethyl methacrylate (PMMA)-based resin, a polycarbonate (PC)-based resin, a polystyrene (PS)-based resin, a polyethylene terephthalate (PET)-based resin, a polyvinyl chloride (PVC)-based resin, and a cellulose-based resin or the like.

When the glass plate 2 is formed from an inorganic glass, the glass plate 2 may be a non-toughened glass or a toughened glass. A non-toughened glass is a glass resulting from molding molten glass into a plate shape and gradually cooling. A toughened glass is glass formed with a compression stressed layer on a surface of a non-toughened glass, and may be air cooled toughened glass or chemically toughened glass. Moreover, the glass plate 2 may be a glass plate that absorbs ultraviolet radiation or infrared radiation. The glass plate 2 may be transparent, or may be tinted to an extent that does not impede transparency.

The mounting member 7 is fixed to a main face on one side of the glass plate 2 with the resin layer 8 interposed therebetween. The resin layer 8 may be an adhesive and may be a pressure-sensitive adhesive. The pressure-sensitive adhesive may also be a pressure-sensitive tape. The exciter 3 is fixed to a face on the opposite side of the mounting member 7 to the glass plate 2 side, with the connection member 6 interposed therebetween. Note that the mounting member 7 and the resin layer 8 may be omitted, with the exciter 3 being fixed to a main face on one side of the glass plate 2 with the connection member 6 interposed therebetween. The connection member 6, similarly to the resin layer 8, may be an adhesive and may be a pressure-sensitive adhesive. Note that the exciter 3 may, for example, be fixed to the connection member 6 using a fastening component such as screws or the like.

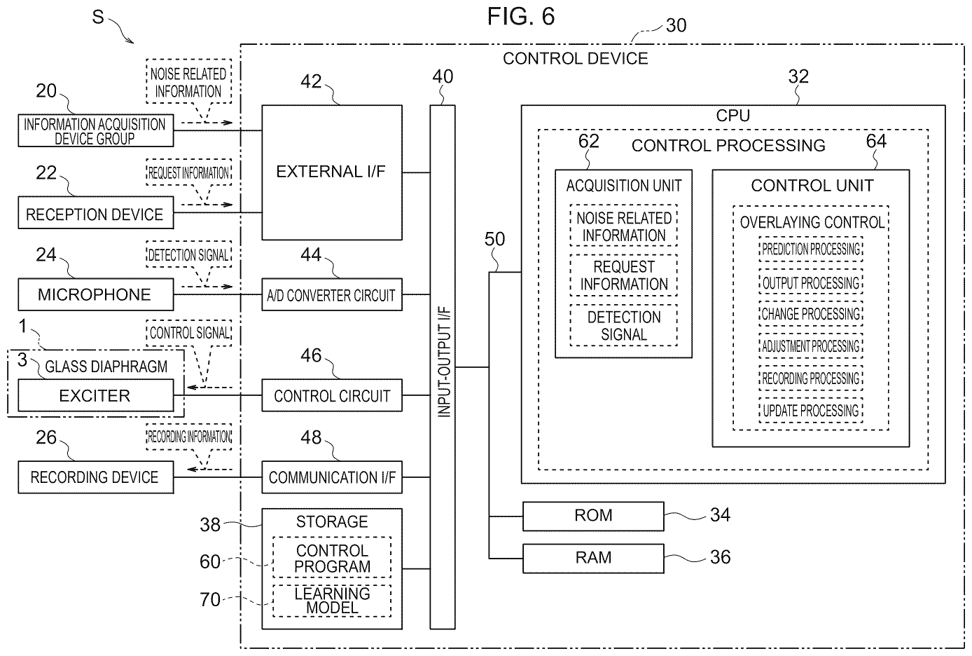

The exciter 3 is connected to a control circuit 46 (see FIG. 6), described later, and vibrates the glass plate 2 according to a control signal input from the control circuit 46. An example of the exciter 3 is a voice coil actuator. A voice coil actuator includes a coil (omitted in the drawings) and a magnetic circuit (omitted in the drawings). One out of the coil or the magnetic circuit is fixed to the mounting member 7 through the connection member 6, and the other thereof is arranged so as to be able to move relatively with respect to the mounting member 7. Then by flowing current through the coil according to a control signal, vibration is generated by interaction between the coil and the magnetic circuit, and the vibration of the exciter 3 is transmitted to the glass plate 2 through the mounting member 7. The glass plate 2 accordingly vibrates, and sound is generated from the glass diaphragm 1. Note that the actuator employed in the exciter 3 is selectable from out of freely selected actuator types capable of exciting the glass plate 2, such as a voice coil actuator, a piezo actuator, or the like. Moreover, as long as the glass plate 2 can be excited and audio can be output, the device for exciting the glass plate 2 is not limited to being an actuator.

### Glass Diaphragm Application Target

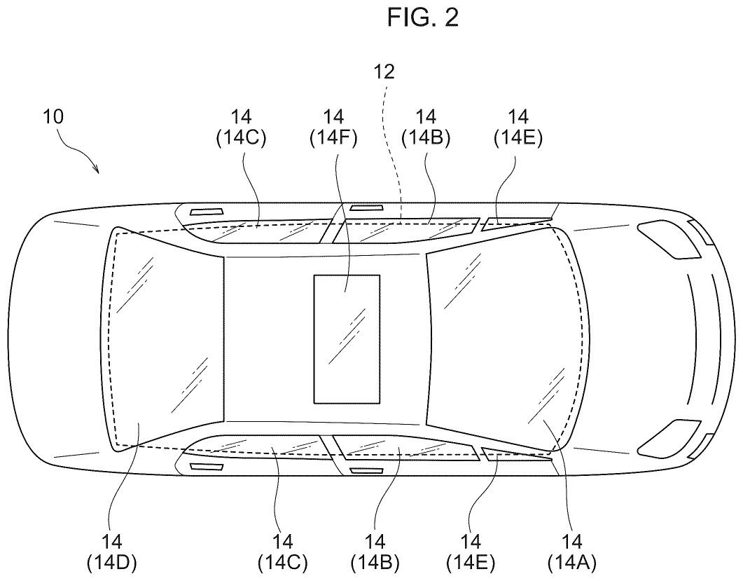

Next, description follows regarding an application target of the glass diaphragm 1. FIG. 2 illustrates a vehicle 10 serving as an application target. The vehicle 10 is an example of a “moving body” of the present disclosure. The vehicle 10 is, as an example, an automobile. Note that other than being an automobile, the vehicle 10 may also be a bus, a truck, a special purpose vehicle, or construction machinery. Moreover, the vehicle 10 may be an internal combustion vehicle with an internal combustion engine as the drive source, may be a hybrid vehicle with an internal combustion engine and an electric motor as drive sources, and may be an electric vehicle with an electric motor as a drive source. Furthermore, other than the vehicle 10, the application target may be a moving body such as an airplane, a helicopter, a drone, or a ship. An example will be described below in which the vehicle 10, which is an automobile (in particular a four-door sedan vehicle), is the application target.

The vehicle 10 includes a cabin interior 12. The vehicle 10 is provided with plural sheets of glass 14 positioned between the cabin interior 12 and the exterior of the vehicle 10. The plural sheets of glass 14 include front window glass 14A, front side window glass 14B, rear side window glass 14C, rear window glass 14D, front quarter window glass 14E, and roof glass 14F. Note that, as other glass, the vehicle 10 may include rear quarter window glass, and may include a glass mirror. The glass mirror may be a rear-view mirror or a door mirror. The vehicle 10 may include glass fitted to the cabin interior 12 as other glass. Examples of glass fitted to the cabin interior 12 include, for example, glass provided on the surface of a display of a navigation system, display/audio system, or the like.

The vehicle 10 may also include a glass other than these examples. The glass diaphragm 1 (see FIG. 1) may be applied to at least one glass 14 from out of the plural glass 14 fitted to the vehicle 10. Note that in the following description, when there is no need to discriminate between the glass diaphragm 1 and the glass 14 other than the glass diaphragm 1, then the glass diaphragm 1 and the glass 14 other than the glass diaphragm 1 will be referred to as “glass 14”.

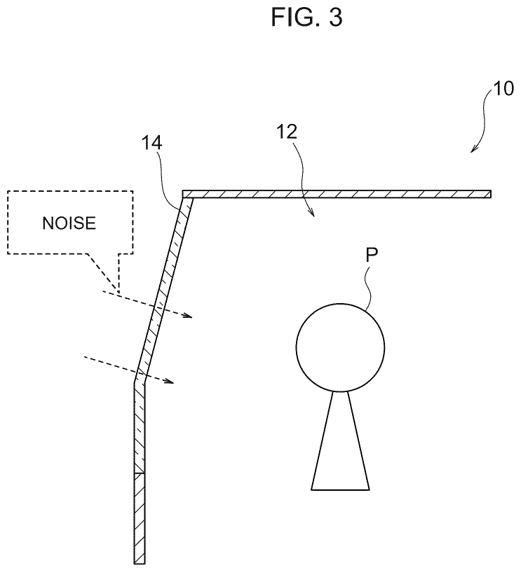

As illustrated in FIG. 3, generally noise flows into the cabin interior 12 from outside of the vehicle 10 when a vehicle 10 is traveling. Examples of such noise include wind noise, road noise, and the like. In contrast to sound absorption material provided to interior finishing materials of the vehicle 10, no sound absorption material is provided to the glass 14 of the vehicle 10, and so noise flows into the cabin interior 12 through the glass 14 more easily than through the interior finishing materials. There is accordingly a concern than the comfort of the cabin interior 12 may be negatively impacted by the noise flowing into the cabin interior 12. In particular, the noise audible to an occupant P is louder in cases in which noise flows in from the glass 14 disposed at positions near to the occupant P. Note that although the example illustrated in FIG. 3 gives an example in which the noise passes through the glass 14, the type of noise is not limited to being air propagated noise passing through the glass 14, and there is also solid propagated noise arising from vibrations that have been transmitted to the vehicle body, such as engine vibration, vibration of tires, suspension, and the like when passing over unevenness and steps in a road, and have then excited the glass 14, which is one of the body configuring members. Namely, this noise may by any sound as long as it is noise that flows into the cabin interior 12 such as, for example, road noise, drumming noise, wind noise, confined sound, tire noise, or oncoming vehicle passing sound.

In consideration of the above circumstances, an object of the present exemplary embodiment is to provide a control device and control program for a glass diaphragm that are capable of improving comfort in a cabin interior 12 by generating overlaying sound from the glass diaphragm 1 to be overlaid with the noise. Specific description thereof follows.

### Overlaying Sound

Description follows regarding overlaying sound generated from the glass diaphragm 1. The overlaying sound is sound to reduce discomfort felt by an occupant P by being overlaid on noise. Examples of types of overlaying sound include environmental sound, music, pseudo noise, and sound having an inverse phase to the noise. The environmental sound may be the sound of rain, sound of a forest, sound of a stream, sound of a seashore, sound of a riverside, tweeting of birds, or a city bustle noise. Music may be music from a radio broadcast, music from a TV broadcast, music reproduced over the Internet, or music reproduced by reading data recorded on various media. Moreover, the music may be music selected by the occupant P. The pseudo noise may be electronic sound, engine sound, or driving sound. When the vehicle 10 is a hybrid vehicle or an electric vehicle, the engine sound may be the engine sound of a sports car, supercar, or various race cars. Inverse phase sound indicates sound including waves of the same frequency as the noise but having a phase 180° opposite thereto.

When the overlaying sound is environmental sound, music, or pseudo noise, the perceived effect of the noise on the occupant is lowered by overlaying the overlaying sound on the noise, thereby reducing the noise audible to the occupant P. However, when the overlaying sound is inverse phase sound, overlaying the overlaying sound on the noise results in a combined waveform with the noise and inverse phase sound superimposed on each other, the amplitude of the combined waveform is reduced, and the noise audible to the occupant P is reduced thereby. Note that the overlaying sound may include two or more types of overlaying sound. For example, the overlaying sound may be a freely selected combination of sounds, such as an engine sound and a sound of rain, or a sound of a forest and inverse phase sound to the noise.

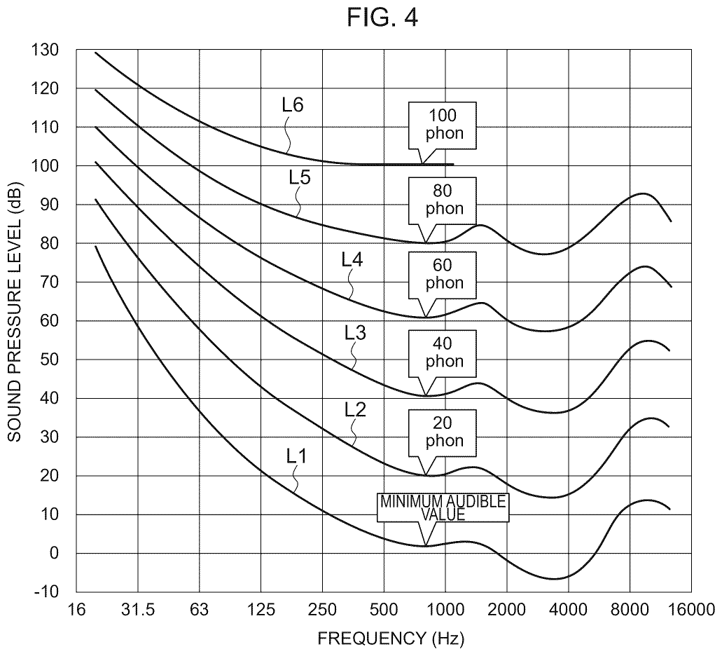

The overlaying sound may be a sound at a higher level than the noise. A higher level sound than the noise may, for example, be as defined by an equivalent loudness curve as illustrated in FIG. 4. An equivalent loudness curve is as defined in ISO 226: 2003 as specified by the International Organization for Standardization (ISO). Equivalent loudness curves indicate lines connecting frequencies (Hz) and sound pressure levels (dB) that are perceived as being sounds of equivalent loudness by human perception and, as an example, include lines L1 to L6 indicating plural sound level's.

The line L1 illustrates a sound level of a minimum audible value, the line L2 illustrates a sound level of 20 phon, line L3 illustrates a sound level of 40 phon, line L4 illustrates a sound level of 60 phon, line L5 illustrates a sound level of 80 phon, and line L6 illustrates a sound level of 100 phon.

For example, when the noise level is 20 phon, overlaying sound louder than the noise is sound having a frequency (Hz) and a sound pressure level (dB) corresponding to the area above line L2. The combination of frequency (Hz) and sound pressure level (dB) may be freely selected. Note that the overlaying sound level may be set so as not to exceed an upper limit value of sound level predetermined as being acceptable to the occupant P. The upper limit value may be freely determined by performing evaluation tests related to the sound level acceptable to the occupant P. For example, in cases in which the overlaying sound is environmental sound, music, or pseudo noise, the perceived effect on the occupant is lowered when the overlaying sound has a sound pressure level at least 1 Db greater than noise of the sound level indicted by each line L1 to L6, with at least 3 dB being preferable, and at least 5 dB being more preferable. However, for example, in cases in which the overlaying sound is opposite phase sound, then the overlaying sound is preferably about the same sound pressure level as the noise of the sound level indicted by each line L1 to L6, with a sound pressure level that is 3 dB louder or greater actually being felt as annoying by an occupant.

### Control System Configuration

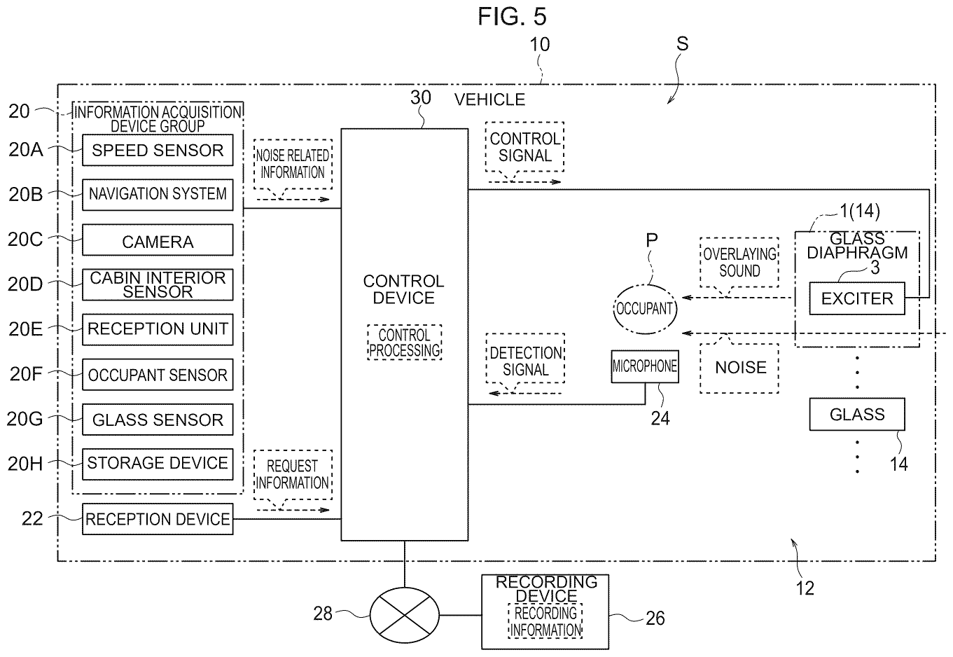

Next, description follows regarding a configuration of a control system provided to a glass diaphragm control device. As illustrated in FIG. 5, a control system S is employed in the vehicle 10. The control system S includes an information acquisition device group 20, a reception device 22, a glass diaphragm 1 control device 30 (hereinafter also called “control device 30”), the glass diaphragm 1, a microphone 24, and a recording device 26.

The information acquisition device group 20, the reception device 22, the control device 30, the glass diaphragm 1, and the microphone 24 are installed to the vehicle 10. The information acquisition device group 20, the reception device 22, the glass diaphragm 1 exciter 3, and the microphone 24 are connected so as to be able to communicate with the control device 30. The connections to the control device 30 may, for example, employ a communication standard such as controller area network (CAN) or the like.

The recording device 26 is, for example, an external server. The recording device 26 is connected to the control device 30 so as to be able to communicate therewith over a network 28. Examples of the network 28 include a local area network (LAN), a Wide Area Network (WAN), the Internet, and the like. Note that the recording device 26 may be configured by storage 38 (see FIG. 6), described later, or by are hard disk or the like provided to a navigation system 20B.

The information acquisition device group 20 is equipped with plural devices for acquiring information related to noise flowing into the cabin interior 12 from outside the vehicle 10 (hereafter referred to as “noise related information”). The noise related information refers to information related to the factors that affect the noise level. As an example, the information acquisition device group 20 includes a speed sensor 20A, the navigation system 20B, a camera 20C, a cabin interior sensor 20D, a reception unit 20E, an occupant sensor 20F, a glass sensor 20G, and a storage device 20H.

The speed sensor 20A is a device to acquire speed information related to the speed of the vehicle 10. The speed information may be the speed of the vehicle 10, and may be the revolution speed of the wheels. Note that the speed information may be detected by sensor(s), or may be acquired based on position information in the navigation system 20B.

The navigation system 20B is a device to acquire travel path information related to the travel path traveled by the vehicle 10. The travel path is an example of a “moving path” of the present disclosure. The travel path information may include at least one out of gradient, width, shape, or classification of the travel path being travelled by the vehicle 10.

The shape of the travel path indicates a shape in plan view of the travel path. Examples of the shape of the travel path include a straight road, a curve, a corner bend, a T-junction, a crossroads, and the like. Examples of the travel path classification include a paved road, an unpaved road, an ordinary road, an express road, and the like. Note that a mobile terminal for executing a navigation application, such as a smartphone or the like, and an audio system connected so as to be able to communicate therewith, may be employed instead of the navigation system 20B.

The camera 20C is a device for acquiring image information related to an image obtained by imaging the travel path being travelled by the vehicle 10. The camera 20C may be installed at any position on the vehicle 10 as long as the travel path can be imaged. The image information may include image data representing an image, and may include image processing information obtained by executing image processing on an image. The image processing information may include condition information indicating a condition of the travel path. The condition information may, for example, include information indicating a degree of dryness or a degree of wetness of the travel path, and may include information indicating a degree of roughness of the travel path. The degree of roughness of the travel path may be a degree indicating a number, size, or height difference of unevenness on the travel path.

The cabin interior sensor 20D is a device to acquire cabin interior information related to a state of the cabin interior 12. The cabin interior sensor 20D may be a camera and may be an object sensor. When a camera is employed as the cabin interior sensor 20D, the camera may be installed at any position in the cabin interior 12 as long as it is capable of imaging the interior of the cabin interior 12. The image information obtained by the camera serving as the cabin interior sensor 20D may include image data representing an image, and may include image processing information obtained by executing image processing on an image.

The cabin interior information may include state information indicating a state of the interior of the cabin interior 12. The state information may, for example, include information indicating a size, type, or position of an object disposed in the interior of the cabin interior 12. Moreover, the cabin interior sensor 20D may be a sensor for detecting a position of a movable member (omitted in the drawings) provided to the cabin interior 12.

The movable member may be a sun visor or sun shade. Moreover, the movable member may be a member having sound absorption properties, sound blocking properties, or the property of reflecting sound. The cabin interior information may include position information related to the position of a movable member. Moreover, the cabin interior information may include at least some information from out of humidity or temperature of the cabin interior 12. Moreover, the cabin interior information may include information about a rotation speed of a fan or the like when an air conditioner has been operated.

The reception unit 20E is a device for acquiring meteorological information related to the meteorology in the area travelled by the vehicle 10. The reception unit 20E may be an audio system for receiving meteorological information transmitted from an information providing device. The information providing device may be a mobile terminal for executing a meteorological forecasting application, such as a smartphone or the like, and may be a server that broadcasts meteorological information. Meteorological information may include at least some information from out of weather information indicating a type of weather, air temperature information indicating an air temperature, windspeed information indicating a windspeed, and wind direction information indicating wind direction. Note that instead of the reception unit 20E, meteorological information may be acquired by the navigation system 20B.

The occupant sensor 20F is a device for acquiring occupant information related to an occupant P. The occupant information may include information indicating a position of an occupant P, and may include information indicating a number of the occupants P. A pressure sensor or a load sensor provided to a seat may be employed as the occupant sensor 20F. Moreover, occupant information may be acquired by a camera provided in the cabin interior 12 instead of by the occupant sensor 20F. Moreover, the occupant information may include information related to at least some out of a posture or state of the occupant P. The posture of the occupant P may be defined based on an angle of inclination of a seatback. The state of the occupant P may be a state as to whether or not the occupant is driving, or as to whether or not the occupant is sleeping.

The glass sensor 20G is a device for acquiring glass state information related to the state of the glass 14. The glass state information is an example of “glass information” of the present disclosure. The glass state information may include information related to the state of the glass diaphragm 1, and may include information related to the state of a glass 14 other than the glass diaphragm 1. For example, in cases in which the glass diaphragm 1 is an openable glass, the glass state information may include information indicating the degree of opening of the glass diaphragm 1. Moreover, in cases in which the vehicle 10 includes an openable glass other than the glass diaphragm 1, the glass state information may include information indicating the degree of opening of this openable glass. Moreover, in cases in which the vehicle 10 includes plural openable glass, the glass state information may include information indicating the position and degree of opening of each of the openable glass.

Moreover, the glass state information may include at least one out of temperature of the glass 14, pressure acting on the glass 14 due to running wind, speed of wind flowing along the glass 14, or amount of wind flowing over the glass 14.

The storage device 20H is a device for storing various information related to noise. The storage device 20H is configured from a hard disk or the like. The storage device 20H may be configured by the storage 38 (see FIG. 6), described later. The various information related to noise may include glass characteristic information related to the characteristics of the glass 14. The glass characteristic information is an example of “glass information” of the present disclosure. The glass characteristic information may include information related to at least some out of material, strength, rigidity, dimensions, and shape of the glass diaphragm 1 (or more specifically, of the glass plate 2 illustrated in FIG. 1). Moreover, the various information related to noise may include interior finishing material characteristic information related to noise absorption characteristics of interior finishing materials.

Note that the noise related information acquired by the information acquisition device group 20 does not necessarily include any of the plural information described above, and may include information related to noise other than the above information.

The reception device 22 is a device for receiving request information related to a request of the occupant P for overlaying sound. Examples of the reception device 22 include a touch panel display, a switch, a controller, or the like. Moreover, the reception device 22 may be an audio system connected so as to be able to communicate with a mobile terminal such as a smartphone or the like. The request of the occupant P may include a request instructing to change the overlaying sound. A request instructing to change the overlaying sound may include a request instructing to change the overlaying sound level. The request instructing to change the overlaying sound level may include a request instructing to change at least one out of a frequency band or sound pressure range of the overlaying sound.

Moreover, the request instructing to change the overlaying sound may include a request instructing to change the type of overlaying sound. The request instructing to change the type of overlaying sound may be a request instructing to change the current overlaying sound to an overlaying sound of a different type. The request instructing to change the current overlaying sound to an overlaying sound of a different type may, for example, be a request instructing to change sound from one out of environmental sound, music, pseudo noise, or inverse phase sound, to another sound. Moreover, the request instructing to change the overlaying sound may include a request instructing to change the current overlaying sound to a different overlaying sound from out of sounds of the same type. Moreover, the request instructing to change the overlaying sound may include a request instructing to change an aspect of the overlaying sound. Examples of aspects of the overlaying sound include tone, melody, tempo, music mode, and the like. The music mode is a mode to select sound of a frequency band for emphasis. Examples of music modes include a vocal mode, a radio mode, a concert mode, a bass mode, a drum mode, a guitar mode, and the like. Moreover, requests of the occupant P may include a request instructing to select a preferred overlaying sound. Moreover, requests of the occupant P may include a request instructing to output two or more types of overlaying sound. For example, the occupant P request may be a request instructing to combine two or more freely selected types of overlaying sound, such engine sound and sound of rain, sound of forest, sound of inverse phase to noise, or the like.

The microphone 24 is a device to detect noise and overlaying sound. The microphone 24 is arranged in the cabin interior 12. The microphone 24 may be provided at any position in the cabin interior 12. For example, the microphone 24 may be provided to each seat, may be provided to each door, and may be provided to each glass 14. Moreover, when the vehicle 10 is equipped with plural glass diaphragms 1, the microphone 24 may be provided to each of the glass diaphragms 1. The microphone 24 outputs a detection signal to the control device 30 that is a result of detected noise and overlaying sound.

Based on noise related information input from the information acquisition device group 20, on request information from the occupant P input from the reception device 22, and on the detection signal input from the microphone 24, the control device 30 executes control processing to generate overlaying sound to be overlaid on noise from the glass diaphragm 1. The control processing includes processing to create a control signal to generate overlaying sound based on the noise related information, the request information, and the detection signal, and processing to output the generated control signal to the exciter 3 of the glass diaphragm 1.

When the control signal from the control device 30 is input to the exciter 3, the glass diaphragm 1 generates overlaying sound by vibrating the exciter 3 according to the control signal. This thereby enables the overlaying sound to be overlaid on the noise, reducing discomfort felt by the occupant P, and enabling the comfort of the cabin interior 12 to be improved.

Note that the glass 14 through which the noise passes may be any glass 14 from out of the plural glass 14 installed to the vehicle 10. FIG. 5 illustrates an example of a case in which, from out of the plural glass 14, the glass 14 nearest to the occupant P is the glass diaphragm 1, and in which the overlaying sound generated by the glass diaphragm 1 is overlaid on noise that has passed through the glass diaphragm 1. In the example illustrated in FIG. 5, the overlaying sound generated by the glass diaphragm 1 can be overlaid on the noise that has passed through the nearest glass diaphragm 1 to the occupant P, and so any discomfort felt by the occupant P can be reduced effectively.

The recording device 26 is a device to record recording information including the detection signal. As an example, the recording information is information including associated information in which the detection signal has been associated with noise related information.

### Glass Diaphragm Control Device Configuration

Description follows regarding a configuration of the control device 30. As illustrated in FIG. 6, the control device 30 includes a central processing unit (CPU) 32, read only memory (ROM) 34, random access memory (RAM) 36, storage 38, an input-output interface (I/F) 40, an external I/F 42, an A/D converter circuit 44, a control circuit 46, and a communication I/F 48.

Note that the control device 30 may be implemented by part of an electronic control unit (ECU), which is a vehicle control computer, and may be implemented by an onboard computer separate to an ECU. The control device 30 is an example of a “computer”.

The CPU 32, the ROM 34, the RAM 36, and the input-output I/F 40 are connected together by a bus 50. The external I/F 42, the A/D converter circuit 44, the control circuit 46, communication I/F 48, and the storage 38 are connected to the input-output I/F 40.

The CPU 32 executes various programs. Specifically, the CPU 32 reads a program stored on the ROM 34 or the storage 38, and executes the program using the RAM 36 as a work area. The CPU 32 performs various computation processing according to the program.

The ROM 34 stores various programs and various data. The RAM 36 serves as a work area for temporarily storing programs and/or data. The storage 38 is configured by a recording medium such as a hard disk drive (HDD), solid state drive (SSD), or flash memory. The storage 38 is stored with various programs including an operating system, and various data for computational processing.

The A/D converter circuit 44 is electrically connected to the microphone 24. The A/D converter circuit 44 creates a digital detection signal by performing A/D conversion on an analogue detection signal detected by the microphone 24.

The control circuit 46 is electrically connected to the exciter 3 of the glass diaphragm 1. The control circuit 46 creates a control signal based on control parameters output from the control device 30, and outputs the created control signal to the exciter 3. The exciter 3 is accordingly vibrated according to the control signal, and overlaying sound corresponding to the control parameters is generated from the glass diaphragm 1.

A control program 60 is stored in the storage 38. The control program 60 is an example of a “computer program product” of the present disclosure. Note that the control program 60 may be stored on the ROM 34. The CPU 32 reads the control program 60, and executes the control program 60 using the RAM 36 as a work area. The CPU 32 executes control processing according to the control program 60. The control processing is executed by the CPU 32 acting as an acquisition unit 62 and a control unit 64 according to the control program 60.

The acquisition unit 62 acquires noise related information input from the information acquisition device group 20 to the CPU 32 through the external I/F 42, acquires request information input from the reception device 22 to the CPU 32 through the external I/F 42, and acquires a detection signal input from the A/D converter circuit 44 to the CPU 32.

The control unit 64 performs control (herein referred to as “overlaying control”) to generate the overlaying sound from the glass diaphragm 1 based on the noise related information, request information, and detection signal acquired by the acquisition unit 62. The overlaying control includes prediction processing, output processing, change processing, adjustment processing, recording processing, and update processing.

The prediction processing is processing to predict the overlaying sound that should be generated from the glass diaphragm 1, based on the noise related information acquired by the acquisition unit 62. A learning model 70 is used in the prediction processing. The learning model 70 is stored in the storage 38. The learning model 70 may be a deep learning model. A deep learning model may be a neural network model. The learning model 70 is a trained model that has been trained using plural sets of pre-obtained training data configured by noise related information as input data and information related to overlaying sound corresponding to the noise related information as output data.

Note that various learning models may be employed as the learning model 70, such as a linear regression model, a logistic regression model, a random forest model, a Boosting model, a support vector model, an autoregressive model, or the like. In the prediction processing, the learning model 70 is employed to derive information related to the overlaying sound. Note that in the prediction processing, instead of using the learning model 70, the information related to the overlaying sound may be derived by employing a computation equation to derive information related to the overlaying sound based on the noise related information.

The information related to the overlaying sound may include an overlaying sound level, and may include at least one out of a frequency band or a sound pressure range of the overlaying sound. Moreover, the information related to the overlaying sound may include information defining the overlaying sound type, and may include information defining the overlaying sound aspect. Moreover, the noise level audible to the occupant P in a state overlaid by the overlaying sound may be set to an overlaying sound level predicted by the prediction processing so as not to exceed the upper limit value of sound level predetermined as being acceptable to the occupant P.

Moreover, in the prediction processing illustrated in FIG. 6, the noise may be predicted based on the noise related information acquired by the acquisition unit 62. Moreover, in the prediction processing, the learning model 70 may be a model trained using plural sets of pre-obtained training data configured by noise related information as input data and information related to noise corresponding to the noise related information as output data. Then, in the prediction processing, the learning model 70 may be employed to derive the information related to noise. Moreover, in the prediction processing, the information related to noise may be derived by employing a computation equation instead of the learning model 70.

The information related to noise may include a noise level, and may include at least one out of a frequency band or sound pressure range of noise. Moreover, the information related to noise may include information to identify a noise type, and may include information to identify a noise aspect. The noise type may be running wind or wind noise. The noise aspect may include a noise tempo.

Output processing is processing to decide control parameters for generating the overlaying sound from the glass diaphragm 1 based on the noise derived by the prediction processing or on the information related to the overlaying sound. In the processing to decide the control parameters, a learning model different to the learning model 70 may be employed, a computation equation may be employed, and pattern matching may be employed. Then, in the output processing, the decided control parameters are output to the control circuit 46. A control signal corresponding to the control parameters is accordingly created by the control circuit 46, the exciter 3 is vibrated based on the created control signal, and the overlaying sound corresponding to the control parameters is generated from the glass diaphragm 1.

Change processing is processing to change the overlaying sound. The change processing is executed based on the request information acquired by the acquisition unit 62. Specifically, the change processing is processing to change the control parameters created by the output processing based on request information. For example, in cases in which a request instructing to change the overlaying sound level is contained in the request information, the control parameters are changed based on the request instructing to change the overlaying sound level. The overlaying sound level may be changed by changing at least one out of the frequency band or sound pressure range of the overlaying sound. Moreover, for example, in cases in which a request instructing to change the overlaying sound type is contained in the request information, the control parameters are changed based on the request instructing to change the overlaying sound type.

Moreover, for example, in cases in which a request instructing to change from the current overlaying sound to an overlaying sound of a different type is contained in the request information, the control parameters are changed based on the request instructing to change to the overlaying sound of different type. Moreover, for example, in cases in which a request instructing to change to a different overlaying sound of the same type to the current overlaying sound is contained in the request information, the control parameters are changed based on the request instructing to change to the different overlaying sound. Moreover, for example, in cases in which a request instructing to change an overlaying sound aspect is contained in the request information, the control parameters are changed based on the request instructing to change the overlaying sound aspect.

The adjustment processing is processing to adjust the overlaying sound. The adjustment processing is executed based on the detection signal acquired by the acquisition unit 62. In cases in which the noise or overlaying sound has been predicted in the prediction processing, there is still a possibility that an error occurs between the predicted result in relation to the noise reduction effect and the actual result, and so processing is performed in the adjustment processing to make such an error small. Specifically, in the adjustment processing, the noise level audible to the occupant P (namely, the noise level audible to the occupant P in a state overlaid by the overlaying sound) is derived based on the detection signal, and determination is made as to whether or not the derived noise level has exceeded the upper limit value of sound level predetermined as being acceptable to the occupant P.

Then, in cases in which the derived noise level exceeds the upper limit value, the control parameters are adjusted such that the noise level does not exceed the upper limit value. Note that the adjustment processing may be configured such that the overlaying sound level audible to the occupant P is derived based on the detection signal, and then determination is made as to whether or not the derived overlaying sound level has exceeded the predetermined upper limit value of sound level predetermined as being acceptable to the occupant P. Then in cases in which the derived overlaying sound level exceeds the upper limit value, the control parameters may be adjusted such that the overlaying sound level does not exceed the upper limit value. The upper limit value corresponding to the overlaying sound may be different to the upper limit value corresponding to the noise.

The processing to adjust the control parameters may include processing to adjust the overlaying sound level. The overlaying sound level may be adjusted by at least one out of the frequency band or sound pressure range of the overlaying sound being adjusted.

Moreover, the processing to adjust the control parameters may include processing to change the overlaying sound type, and may include processing to change to a different overlaying sound type to that of the current overlaying sound. Moreover, the processing to adjust the control parameters may include processing to change to a different overlaying sound from out of the same type to the current overlaying sound, and may include processing to change the overlaying sound aspect.

The recording processing is processing to record recording information containing the detection signal in the recording device 26. The recording information may include associated information in which the detection signal has been associated with the noise related information. The noise related information contained in the associated information is information indicating a generation condition of the noise when the detection signal was obtained.

The update processing is processing to update coefficients employed in the prediction processing based on the recording information. Specifically, in the update processing, the noise level audible to the occupant P (namely, the noise level audible to the occupant P in a state overlaid by the overlaying sound) is derived based on the detection signal, and determination is made as to whether or not the derived noise level has exceeded the upper limit value of sound level predetermined as being acceptable to the occupant P. Then in cases in which the derived noise level has exceeded the upper limit value, the coefficients are updated using the associated information so as to obtain an overlaying sound such that the noise level does not exceed the upper limit value. This update processing may be successively executed, may be executed after the vehicle 10 has finished traveling, and may be executed periodically.

Note that the update processing may be configured such that the overlaying sound level audible to the occupant P is derived based on the detection signal, and then determination is made as to whether or not the derived overlaying sound level exceeds the upper limit value of sound level predetermined as being acceptable to the occupant P. Then in cases in which the derived overlaying sound level has exceeded the upper limit value, the coefficients may be updated using the associated information such that the overlaying sound level does not exceed the upper limit value. The upper limit value corresponding to the overlaying sound may be different to the upper limit value corresponding to the noise.

The coefficients updated in the update processing may be coefficients employed in the learning model 70 in a process to derive information related to the noise or the overlaying sound from the noise related information. For example, the coefficients may be neural network weights (namely, strengths of synaptic connections). Note that in the prediction processing, in cases in which, instead of the learning model 70, a computation equation is employed to derive information related to the noise or overlaying sound based on the noise related information, the coefficients updated by the update processing may be coefficients contained in the computation equation.

### Glass Diaphragm Control Device Operation

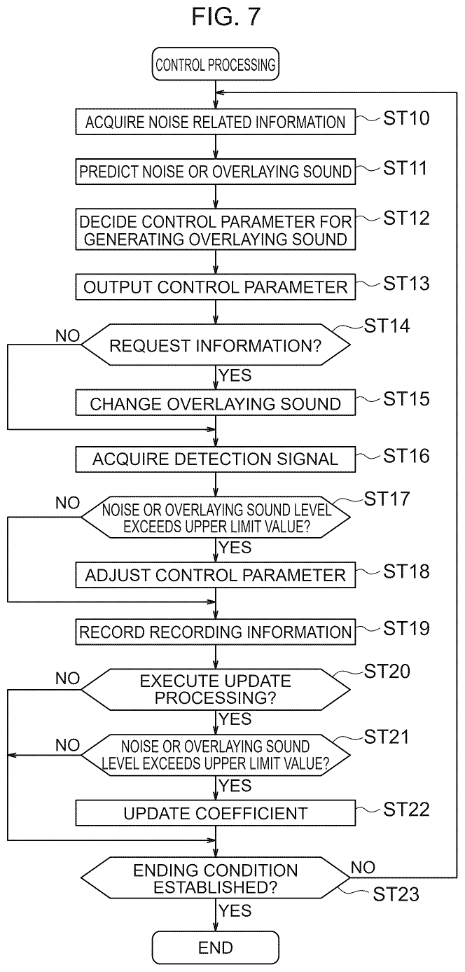

Description follows regarding a flow of control processing in operation of the control device 30. FIG. 7 illustrates an example of a flow of control processing.

Firstly, at step ST10, the CPU 32 acquires the noise related information input to the CPU 32 from the information acquisition device group 20.

Next, at step ST11, the CPU 32 predicts the noise or overlaying sound based on the noise related information acquired at step ST10.

Next, at step ST12, the CPU 32 decides the control parameters to generate the overlaying sound from the glass diaphragm 1 based on the noise or overlaying sound predicted at step ST11.

Next, at step ST13, the CPU 32 outputs the control parameters decided at step ST12 to the control circuit 46. This means that the control signal corresponding to the control parameters is created by the control circuit 46, the exciter 3 is vibrated based on the created control signal, and the overlaying sound corresponding to the control parameters is generated from the glass diaphragm 1.

Next, at step ST14, the CPU 32 determines whether or not request information has been input to the CPU 32 from the reception device 22. The control processing transitions to step ST15 when there is request information. The control processing transitions to step ST16 when there is no request information.

At step ST15, the CPU 32 changes the overlaying sound based on the request information.

At step ST16, the CPU 32 acquires the detection signal input to the CPU 32 from the microphone 24 through the A/D converter circuit 44.

Next, at step ST17, based on the detection signal acquired at step ST16, the CPU 32 determines whether or not the noise or overlaying sound level audible to the occupant P has exceeded the upper limit value of sound level predetermined as being acceptable to the occupant P. The control processing transitions to step ST18 when the noise level has exceeded the upper limit value. The control processing transitions to step ST19 when the noise level has not exceeded the upper limit value.

At step ST18, the CPU 32 adjusts the control parameters such that the noise or overlaying sound level does not exceed the upper limit value.

At step ST19, the CPU 32 records the recording information containing the detection signal acquired at step ST16 in the recording device 26.

Next, at step ST20, the CPU 32 determines whether or not to execute update processing. The control processing transitions to step ST21 when update processing is to be executed. The control processing transitions to step ST23 when update processing is not to be executed.

At step ST21, based on the detection signal acquired at step ST16, the CPU 32 determines whether or not the noise or overlaying sound level audible to the occupant P exceeds the upper limit value of sound level predetermined as being acceptable to the occupant P. The control processing transitions to step ST22 when the noise level exceeds the upper limit value. The control processing transitions to step ST23 when the noise level has not exceeded the upper limit value.

At step ST22, the CPU 32 updates the coefficients employed in the prediction processing based on the recording information recorded at step ST19.

At step ST23, the CPU 32 determines whether or not an ending condition to end the control processing has been established. An example of this ending condition is a condition that information instructing to end control processing has been received by the reception device from the occupant P. The control processing returns to step ST10 in cases in which the ending condition has not been established. The control processing is ended when the ending condition has been established.

### Present Exemplary Embodiment Advantageous Effects

Description follows regarding advantageous effect of the present exemplary embodiment.

As described in detail above, in the present exemplary embodiment, the noise related information is acquired related to noise flowing into the cabin interior 12, and overlaying sound to be overlaid with the noise is generated from the glass diaphragm 1 based on the noise related information. This means that discomfort felt by the occupant P can be reduced compared to cases in which there is no overlaying sound, enabling the comfort of the cabin interior 12 to be improved.

Moreover, in the present exemplary embodiment, the target noise is, for example, noise flowing in through the glass diaphragm 1. This means that due to being able to output the overlaying sound generated from the glass diaphragm 1 in response the noise that has flowed in through the same glass diaphragm 1, discomfort felt by the occupant P can be reduced more effectively compared to cases in which, for example, the glass 14 that the noise flows in through is different to the glass diaphragm 1 that generates the overlaying sound.

Moreover, in the present exemplary embodiment, the noise or the overlaying sound is predicted based on the noise related information. As control for generating the overlaying sound, feedback control might be considered in which noise is detected by the microphone 24, and overlaying sound is generated based on the detected noise. However, this is difficult to handle with feedback control because the response speed to calculate the overlaying sound level does not keep up with the noise. Particular difficult is the handling of road noise or wind noise, which have a comparatively fast speeds of propagation compared to stationary sound such as confined sound, and have spasmodic and random characteristics. The present exemplary embodiment accordingly predicts the noise or overlaying sound based on the noise related information, enabling discomfort felt by the occupant P to be reduced more effectively than with feedback control.

Moreover, in the present exemplary embodiment, the learning model 70, which has been trained using plural sets of pre-obtained training data configured by noise related information as input data and information related to noise or overlaying sound corresponding to the noise related information as output data, is employed to derive the information related to noise or overlaying sound. This thereby enables high precision prediction to be performed using the learning model 70.

Moreover, the noise related information includes at least one out of speed information related to the speed of the vehicle 10, travel path information related to the travel path that the vehicle 10 is traveling on, image information related to images obtained by imaging the travel path, vehicle interior information related to the state of the cabin interior 12, meteorological information related to the meteorology of the area the vehicle 10 is traveling in, and occupant information related to the occupant P. This means that information highly correlated to the noise or overlaying sound is employed, enabling prediction to be performed with high accuracy.

Moreover, the noise related information includes glass information related to at least one out of the glass 14 or the glass diaphragm 1 (as an example, glass state information and glass characteristic information). This means that information highly correlated to the noise or overlaying sound is employed, enabling prediction to be performed with high accuracy.

Moreover, in the present exemplary embodiment, the overlaying sound predicted in the prediction processing is, for example, sound louder than the noise. This thereby enables discomfort felt by the occupant P to be reduced more effectively compared to cases in which the overlaying sound is sound softer than the noise.

Moreover, in the present exemplary embodiment, the overlaying sound level predicted by the prediction processing has not exceeded the upper limit value of sound level predetermined as being acceptable to the occupant P. This thereby enables the overlaying sound level to be suppressed to an acceptable level, enabling the suppression of detrimental effects from the overlaying sound on the cabin interior 12 comfort.

Moreover, the overlaying sound can be changed in the present exemplary embodiment. This thereby enables, for example, the overlaying sound to be changed in cases in which the overlaying sound is not to the taste of the occupant P, enabling the cabin interior 12 comfort to be maintained.

Moreover, in the present exemplary embodiment, the request information of requests by the occupant P related to overlaying sound is acquired, and the overlaying sound can be changed based on the request information. This thereby enables the overlaying sound to be matched to the tastes of the occupant P, enabling the cabin interior 12 comfort to be improved compared to cases in which the overlaying sound is unable to be matched to the taste of the occupant P.

Moreover, the overlaying sound can be adjusted in the present exemplary embodiment. This thereby enables, for example, discomfort felt by the occupant P to be effectively reduced by adjusting the overlaying sound in cases in which there is residual noise, enabling the cabin interior 12 comfort to be improved compared to cases in which the overlaying sound is not able to be adjusted.

Moreover, in the present exemplary embodiment, a detection signal detecting the noise and overlaying sound is acquired by the microphone 24, and the overlaying sound is adjusted based on the detection signal. This means that when an error arises between the prediction result related to the noise reduction effect and the actual result, the error can be reduced by adjusting the overlaying sound. This thereby enables the cabin interior 12 comfort to be improved compared to cases in which the error is not reduced.

Moreover, in the present exemplary embodiment, the recording information including the detection signal is recorded on the recording device 26. This thereby enables the coefficients employed in the prediction processing to be updated at a freely selected timing based on the detection signal.

Moreover, the recording information includes associated information in which the detection signal has been associated with noise related information. This thereby enables the coefficients employed in prediction processing to be updated based on the associated information (namely, the information indicating relationships between detection signals and noise related information, which is the condition of noise generation when the detection signal is obtained).

Moreover, in the present exemplary embodiment, the coefficients employed in prediction processing are updated based on the recording information. This thereby enables prediction to be performed with higher accuracy than cases in which the coefficients are unable to be updated.

### Modified Examples of Present Exemplary Embodiment

Description follows regarding modified examples of the present exemplary embodiment.

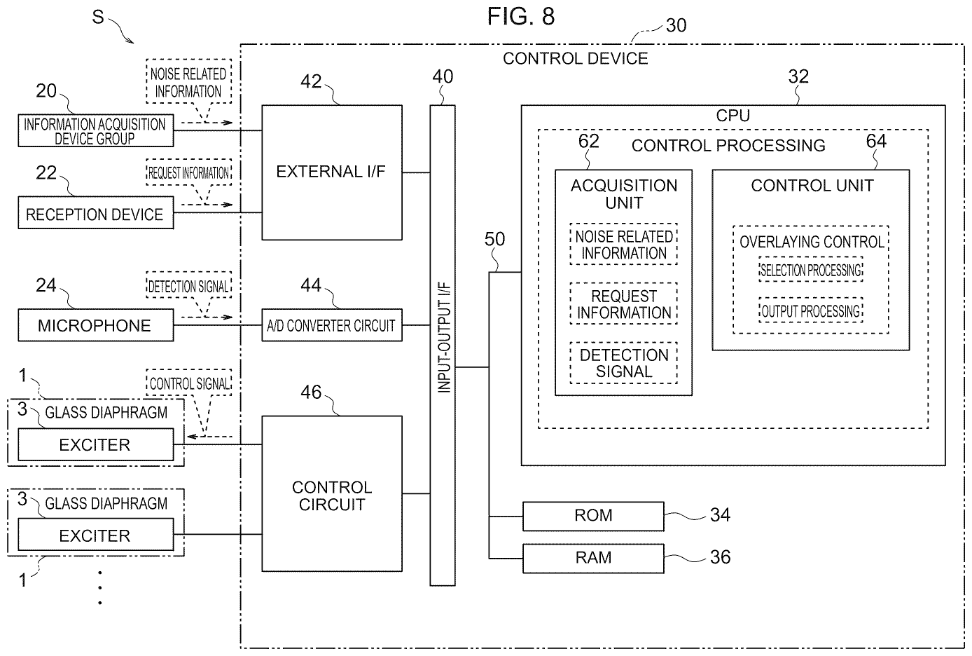

FIG. 8 illustrates a first modified example of the present exemplary embodiment. In the first modified example, a control system S includes plural glass diaphragms 1. There may be any number of the plural glass diaphragms 1. The glass diaphragms 1 may be any out of the front window glass 14A, the front side window glass 14B, the rear side window glass 14C, the rear window glass 14D, the front quarter window glass 14E, the roof glass 14F, the rear quarter window glass, the rear-view mirror, or the door mirror as described with reference to FIG. 2, or another glass. The exciter 3 of each of the glass diaphragms 1 is electrically connected to the control circuit 46.

The overlaying control includes selection processing and output processing. The selection processing is processing based on the noise related information to select, from out of the plural glass diaphragms 1, the glass diaphragm 1 to generate overlaying sound from. In the selection processing, the glass diaphragm 1 most suitable to conditions indicted by the noise related information is selected. For example, based on the noise related information, the glass diaphragm 1 nearest to the occupant P may be selected from out of the plural glass diaphragms 1, and the glass diaphragm 1 through which the most noise passes may be selected from out of the plural glass diaphragms 1.

Moreover, in the selection processing, the glass diaphragm 1 corresponding to a request from the occupant P may be selected based on request information, and the glass diaphragm 1 through which the most noise passes from out of the plural glass diaphragms 1 may be identified based on the detection signal, and this identified glass diaphragm 1 selected.

In the output processing, the control parameters are decided for the glass diaphragm 1 selected by the selection processing. The output processing outputs the control parameters for controlling the selected glass diaphragm 1 to the control circuit 46. A control signal corresponding to the control parameters is according created by the control circuit 46 for the selected glass diaphragm 1, the exciter 3 thereof is vibrated based on the created control signal, and overlaying sound is generated from the glass diaphragm 1.

In the first modified example such as this, the glass diaphragm 1 to generate the overlaying sound is selected from out of the plural glass diaphragms 1, enabling the cabin interior 12 comfort to be improved compared to cases in which the glass diaphragm 1 is not able to be selected.

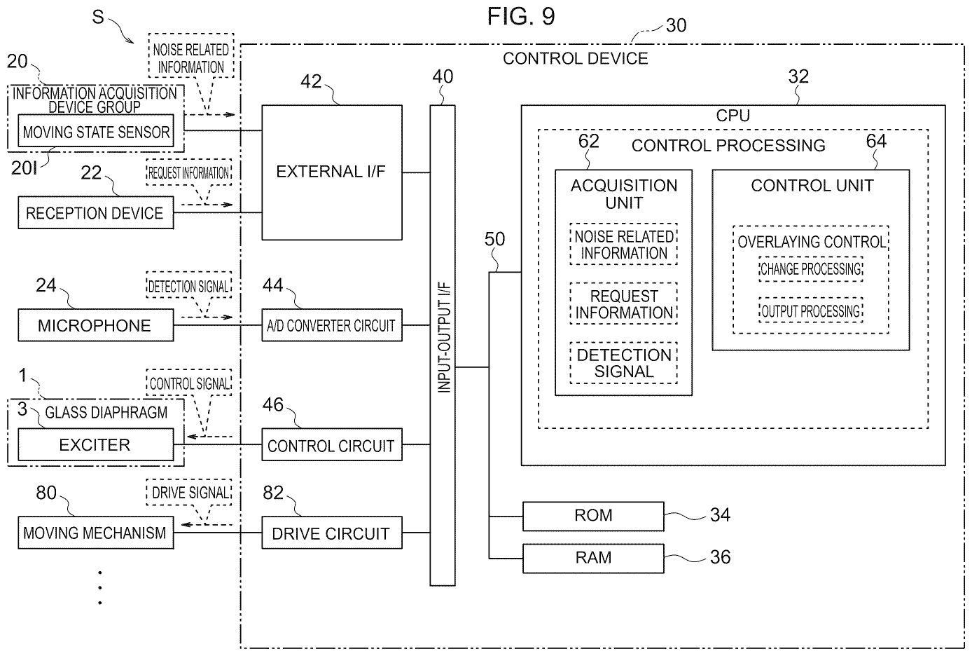

FIG. 9 illustrates a second modified example of the present exemplary embodiment. In the second modified example, the control system S includes a moving mechanism 80. The moving mechanism 80 may be a mechanism that affects the noise level flowing into the cabin interior 12. Examples of the moving mechanism 80 include an opening/closing roof of an open-top car, a sunroof having a sliding function and tilting function, a raising/lowering side window glass, a ventilated side window, a roof ventilator, a movable wind deflector of an open-top car, and the like. The moving mechanism 80 may also include a raising/lowering glass 14.

There may be any number of moving mechanisms 80. Each of the moving mechanisms 80 includes a movable body (omitted in the drawings), and an actuator (omitted in the drawings) to move the movable body. The actuator may be a motor actuator, may be a hydraulic actuator, and may be a pneumatic actuator. The control device 30 includes a drive circuit 82 to drive the moving mechanism 80. The drive circuit 82 is electrically connected to the actuator of the moving mechanism 80.

The information acquisition device group 20 includes a moving state sensor 20I. The moving state sensor 20I is a device for acquiring moving state information related to the moving state of the moving mechanism 80. The moving state may be a state related to a position, degree of opening, orientation, or the like of the movable body. Moreover, the moving state may be a state as to whether the movable body is at an open position or a closed position. The noise related information includes moving state information related to the moving state as acquired by the moving state sensor 20I.

The overlaying control includes change processing and output processing. The change processing is processing to change the moving state of the moving mechanism 80 based on the noise related information. In the change processing, the moving mechanism 80 that affects the noise level is identified based on the noise related information, and the position, degree of opening, orientation, or the like of the movable body is decided for the identified moving mechanism 80 so as to reduce the noise level.

In the output processing, the drive parameters are decided for the moving mechanism 80 identified by the change processing based on the position, degree of opening, orientation, or the like of the movable body decided by the change processing. Then, in the output processing, the drive parameters for driving the identified moving mechanism 80 are output processing to the drive circuit 82. A drive signal corresponding to the drive parameters is accordingly created by the drive circuit 82 for the identified moving mechanism 80, the actuator is driven based on the created drive signal, and the moving state of the moving mechanism 80 is changed.

For example, in cases in which an opening/closing roof of an open-top car has been opened, an increase in the noise level flowing in to the cabin interior 12 is predicted. In such cases, an actuator may be controlled so as to raise the glass diaphragm 1 in order to increase the exposed surface area of the glass diaphragm 1 (namely, the effective surface area capable of generating overlaying sound for the occupant P). Moreover, in cases in which an opening/closing roof of an open-top car has been opened, an actuator may be controlled so as to raise the glass diaphragm 1 in order to increase the exposed surface area of the glass diaphragm 1 configuring a movable wind deflector. Moreover, in cases in which one glass 14 has been opened from out of the plural glass 14, an actuator may be controlled so as to raise the glass diaphragm 1 in order to increase the exposed surface area of the glass diaphragm 1 configuring another glass 14.

Moreover, the change processing may include processing to change the overlaying sound based on the moving state information. Moreover, the processing to change the overlaying sound may include predicting a change in the noise level caused by the moving state of the moving mechanism 80 based on the moving state information, and processing to change the overlaying sound so as to reduce the noise level based on the predicted result.

Moreover, the processing to change the overlaying sound may include processing to change the overlaying sound level. The overlaying sound level may be changed by changing at least one out of the frequency band or sound pressure range of the overlaying sound. Moreover, the processing to change the overlaying sound may include processing to change the overlaying sound type, and may include processing to change to an overlaying sound type different to that of the current overlaying sound. Moreover, the processing to change the overlaying sound may include processing to change to different overlaying sound from out of the same type as the current overlaying sound, and may include processing to change the overlaying sound aspect.

For example, in cases in which an opening/closing roof of an open-top car has been opened, an increase in the noise level flowing into the cabin interior 12 is predicted. In such cases, the exciter 3 may be controlled so as to increase the overlaying sound level generated by the glass diaphragm 1 configuring a side window glass. Moreover, in cases in which an opening/closing roof of an open-top car has been opened, the exciter 3 may be controlled so as to increase the overlaying sound level generated by the glass diaphragm 1 configuring a movable wind deflector. Moreover, in cases in which one glass 14 has been opened from out of plural glass 14, the exciter 3 may be controlled so as to increase the overlaying sound level generated by the glass diaphragm 1 configuring another glass 14.

Moreover, for the same glass diaphragm 1, a combination of processing may be included of processing to change the moving state of the glass diaphragm 1, and processing to change the overlaying sound generated by the glass diaphragm 1.

For example, in cases in which an opening/closing roof of an open-top car has been opened, the glass diaphragm 1 configured by a side window glass may be raised, and the overlaying sound level generated by the same glass diaphragm 1 may be increased. Moreover, in cases in which an opening/closing roof of an open-top car has been opened, the glass diaphragm 1 configured by a movable wind deflector may be raised, and the overlaying sound level generated by the same glass diaphragm 1 may be increased. Moreover, in cases in which one glass 14 has been opened from out of the plural glass 14, the glass diaphragm 1 configured as another glass 14 may be raised, and the overlaying sound level generated by this glass diaphragm 1 increased.

In the second modified example as described above, the noise related information includes moving state information related to the moving state of the moving mechanism 80 that affects the noise level, enabling the noise level caused by the moving state of the moving mechanism 80 to be predicted based on the moving state information.

Moreover, because the moving state of the moving mechanism 80 is changed so as to reduce the noise level based on the moving state information, the comfort of the cabin interior 12 can be improved compared to cases in which the moving state of the moving mechanism 80 is not able to be changed.

Moreover, in cases in which the noise has been change according to the moving state of the moving mechanism 80, the overlaying sound is changed based on the moving state information, enabling changes in noise to be tracked.

Note that in the second modified example the moving state of the moving mechanism 80 may be changed based on request information. Moreover, the moving mechanism 80 that has the greatest effect on the noise level may be identified from out of plural moving mechanisms 80 based on the detection signal, and the moving state for the identified moving mechanism 80 may be changed so as to reduce the noise level.

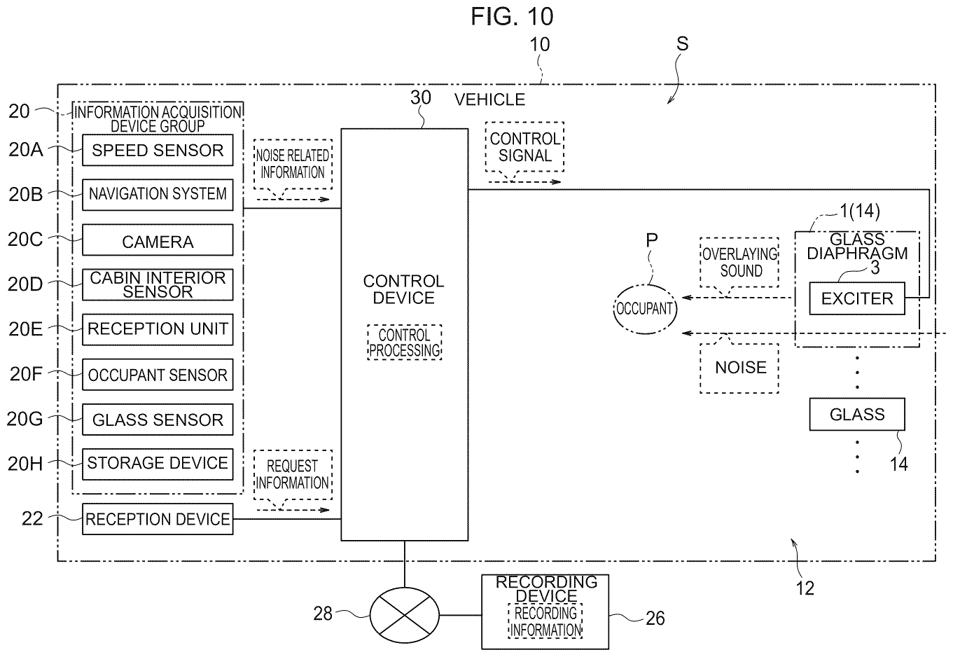

Moreover, although in the above exemplary embodiments the control system S (see FIG. 5) is provided with the microphone 24, and the control processing creates the control signal for generating the overlaying sound based on the detection signal input from the microphone 24 in addition to the noise related information and the request information, the microphone 24 may, for example, be omitted from the control system S as illustrated in FIG. 10, and the control processing may create a control signal to generating the overlaying sound based on the noise related information and the request information.

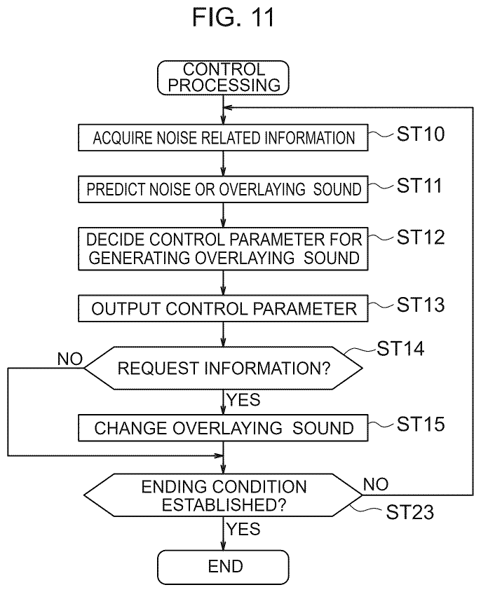

Moreover, although in the above exemplary embodiments the control processing (see FIG. 7) includes the processing to adjust the control parameters based on the detection signal (step ST16 to step ST18), and the processing to update the coefficients based on the recording information (step ST19 to step ST22), for example, as illustrated in FIG. 11, the processing of step ST16 to step ST18, and the processing of step ST19 and step ST22, may be omitted from the control processing.

Moreover, although in the above exemplary embodiments examples have been given of the CPU 32 serving as the control device 30, instead of the CPU 32, or as well as the CPU 32, at least one other CPUs, at least one graphics processing unit (GPU), and/or at least one tensor processing unit (TPU) may be employed.

Moreover, although examples have been given in the above exemplary embodiment in which the control program 60 is pre-stored on the storage 38, the control program 60 may be stored on a portable, non-transitory, computer-readable storage medium (hereinafter simply referred to as “non-transitory storage medium”) such as a solid state drive (SSD), universal serial bus (USB) memory, or the like. The control program 60 stored on the non-transitory storage medium may be installed to the control device 30.

Moreover, the control program 60 may be stored on a storage device of another computer, server device, or the like connected to the control device 30 over a network 28, and the control program 60 downloaded in response to a request of the control device 30 and installed on the control device 30.

Moreover, there is no need for on all the control devices 30 to be stored on a storage device of another computer, server device, or the like connected to the control device 30, or on the storage 38, and it may be stored on some of the control devices 30.

Moreover, although an example is given of the control device 30 in the above exemplary embodiments for a computer containing the CPU 32, the ROM 34, the RAM 36, and the storage 38, instead of a computer, a device including an application specific integrated circuit (ASIC), a field programmable gate array (FPGA), and/or a programmable logic device (PLD) may be employed. Moreover, instead of a computer, a combination of a hardware configuration and the software configuration may be employed.

Moreover, the following various processors may be employed as hardware resource for executing the various processing described for the above exemplary embodiments. Examples of processors include, for example, a CPU that is a general purpose processor functioning as hardware resource to execute various processing software, namely by executing a program. Moreover, examples of processors include dedicated electronic circuits, these being processors including a circuit configuration custom-designed to execute specific processing such as, for example, FPGA, PLD, ASIC, or the like. Any of these processors includes internal memory or is connected to memory, and any of these processors executes various processing using the memory.

The hardware resource for executing the various processing may be configured by a single of these various processors, or may be configured by a combination of two or more of the same or different types of processor (for example, a combination of plural FPGAs or a combination of a CPU and an FPGA). Moreover, the hardware resource for executing the various processing may be a single processor.

Examples of configurations of a single processor include, firstly, a configuration of a single processor combination of one or more CPU and software in a mode in which this processor functions as hardware resource to execute various processing. Secondly, there is a mode, in which a processor is employed to implement functions of an entire system including plural hardware resources for executing various processing with a single integrated circuit (IC) chip, as typified by a system on chip (SOC) or the like. Various processing is implemented using the one or more of the various processors described above as hardware resources in this manner.

Furthermore, more specifically, hardware structures that can be employed for these various processors include an electric circuit combining circuit elements such as semiconductor elements and the like. Moreover, the processing described above is merely an example. Thus obviously, redundant steps may be omitted, new steps may be added, and processing sequence may be changed around, within a range not departing from the spirit thereof.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like, which does not particularly need description to enable implementation of the present disclosure, is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

The following Supplements are disclosed in relation to the above exemplary embodiments.

### Supplement 1

A control device for a glass diaphragm including:
an acquisition unit that is configured to acquire noise related information related to noise flowing into a cabin interior of a moving body; and
a control unit that is configured to perform control to generate overlaying sound to be overlaid with the noise from a glass diaphragm of the moving body based on the noise related information.

### Supplement 2

The glass diaphragm control device of Supplement 1, wherein the noise is noise flowing in through the glass diaphragm.

### Supplement 3

The glass diaphragm control device of Supplement 1 or Supplement 2, wherein the control includes prediction processing to predict the noise or the overlaying sound based on the noise related information.

### Supplement 4

The glass diaphragm control device of Supplement 3, wherein the prediction processing contains processing to derive information related to the noise or the overlaying sound using a learning model trained using plural sets of pre-obtained training data configured by the noise related information as input data and information related to the noise or the overlaying sound corresponding to the noise related information as output data.

### Supplement 5

The glass diaphragm control device of any one of Supplement 1 to Supplement 4, wherein the noise related information includes at least one information selected from the group consisting of speed information related to a speed of the moving body, moving path information related to a moving path the moving body is moving along, image information related to images obtained by imaging the moving body moving path, cabin interior information related to a state of the cabin interior, meteorological information related to meteorology of an area the moving body is moving in, and occupant information related to an occupant of the moving body.

### Supplement 6

The glass diaphragm control device of any one of Supplement 1 to Supplement 5, wherein the noise related information includes glass information related to at least one out of a glass of the moving body or the glass diaphragm.

### Supplement 7

The glass diaphragm control device of any one of Supplement 1 to Supplement 6, wherein the overlaying sound level is higher than the noise level.

### Supplement 8

The glass diaphragm control device of any one of Supplement 1 to Supplement 7, wherein a level of the overlaying sound does not exceed an upper limit value of sound level predetermined as being acceptable to an occupant of the moving body.

### Supplement 9

The glass diaphragm control device of any one of Supplement 1 to Supplement 8, wherein the control includes change processing to change the overlaying sound.

### Supplement 10

The glass diaphragm control device of Supplement 9, wherein:
the acquisition unit acquires request information in relation to the overlaying sound as requested by an occupant of the moving body; and
the change processing is executed based on the request information.

### Supplement 11

The glass diaphragm control device of any one of Supplement 1 to Supplement 10, wherein the control includes adjustment processing to adjust the overlaying sound.

### Supplement 12

The glass diaphragm control device of Supplement 11, wherein:
the acquisition unit acquires a detection signal from detection of the noise and overlaying sound; and
the adjustment processing is executed based on the detection signal.

### Supplement 13

The glass diaphragm control device of any one of Supplement 1 to Supplement 12, wherein:
the acquisition unit acquires a detection signal from detection of the noise and overlaying sound; and
the control includes recording processing to record recording information containing the detection signal in a recording device.

### Supplement 14

The glass diaphragm control device of Supplement 13, wherein:
the recording information contains associated information in which the detection signal has been associated with the noise related information.

### Supplement 15

The glass diaphragm control device of Supplement 13 or Supplement 14, wherein:
the control contains prediction processing to predict the overlaying sound based on the noise related information, and update processing to update a coefficient used in the prediction processing based on the recording information.

### Supplement 16

The glass diaphragm control device of any one of Supplement 1 to Supplement 15, wherein:
the moving body includes plural of the glass diaphragms;
the control includes selection processing to select a glass diaphragm to generate the overlaying sound from out of the plural glass diaphragms based on the noise related information.

### Supplement 17

The glass diaphragm control device of any one of Supplement 1 to Supplement 16, wherein:
the moving body includes a moving mechanism that affects a level of the noise; and
the noise related information includes moving state information related to a moving state of the moving mechanism.

### Supplement 18

The glass diaphragm control device of Supplement 17, wherein:
the control includes change processing to change the moving state based on the noise related information.

### Supplement 19

The glass diaphragm control device of Supplement 18, wherein:
the change processing includes processing to change the overlaying sound based on the moving state information.

### Supplement 20

A control program that causes a computer to execute processing including:
acquiring noise related information related to noise flowing into a cabin interior of a moving body; and
performing control to generate overlaying sound to be overlaid with the noise from a glass diaphragm of the moving body based on the noise related information.

### Supplement 21

A computer program product including a control program that causes a computer to execute processing including:
acquiring noise related information related to noise flowing into a cabin interior of a moving body; and
performing control to generate overlaying sound to be overlaid with the noise from a glass diaphragm of the moving body based on the noise related information.

1. A control device for a glass diaphragm comprising:
an acquisition unit that is configured to acquire noise related information related to noise flowing into a cabin interior of a moving body; and
a control unit that is configured to perform control to generate overlaying sound to be overlaid with the noise from a glass diaphragm of the moving body based on the noise related information.

2. The glass diaphragm control device of claim 1, wherein the noise is noise flowing in through the glass diaphragm.

3. The glass diaphragm control device of claim 1, wherein the control includes prediction processing to predict the noise or the overlaying sound based on the noise related information.

4. The glass diaphragm control device of claim 3, wherein the prediction processing contains processing to derive information related to the noise or the overlaying sound using a learning model trained using plural sets of pre-obtained training data configured by the noise related information as input data and information related to the noise or the overlaying sound corresponding to the noise related information as output data.

5. The glass diaphragm control device of claim 1, wherein the noise related information includes at least one information selected from the group consisting of speed information related to a speed of the moving body, moving path information related to a moving path the moving body is moving along, image information related to images obtained by imaging the moving body moving path, cabin interior information related to a state of the cabin interior, meteorological information related to meteorology of an area the moving body is moving in, and occupant information related to an occupant of the moving body.

6. The glass diaphragm control device of claim 1, wherein the noise related information includes glass information related to at least one out of a glass of the moving body or the glass diaphragm.

7. The glass diaphragm control device of claim 1, wherein the overlaying sound level is higher than the noise level.

8. The glass diaphragm control device of claim 1, wherein a level of the overlaying sound does not exceed an upper limit value of sound level predetermined as being acceptable to an occupant of the moving body.

9. The glass diaphragm control device of claim 1, wherein the control includes change processing to change the overlaying sound.

10. The glass diaphragm control device of claim 9, wherein:
the acquisition unit acquires request information in relation to the overlaying sound as requested by an occupant of the moving body; and
the change processing is executed based on the request information.

11. The glass diaphragm control device of claim 1, wherein the control includes adjustment processing to adjust the overlaying sound.

12. The glass diaphragm control device of claim 11, wherein:
the acquisition unit acquires a detection signal from detection of the noise and overlaying sound; and
the adjustment processing is executed based on the detection signal.

13. The glass diaphragm control device of claim 1, wherein:
the acquisition unit acquires a detection signal from detection of the noise and overlaying sound; and
the control includes recording processing to record recording information containing the detection signal in a recording device.

14. The glass diaphragm control device of claim 13, wherein:
the recording information contains associated information in which the detection signal has been associated with the noise related information.

15. The glass diaphragm control device of claim 13, wherein:
the control contains prediction processing to predict the overlaying sound based on the noise related information, and update processing to update a coefficient used in the prediction processing based on the recording information.

16. The glass diaphragm control device of claim 1, wherein:
the moving body includes a plurality of the glass diaphragms;
the control includes selection processing to select a glass diaphragm to generate the overlaying sound from out of the plurality of glass diaphragms based on the noise related information.

17. The glass diaphragm control device of claim 1, wherein:
the moving body includes a moving mechanism that affects a level of the noise; and
the noise related information includes moving state information related to a moving state of the moving mechanism.

18. The glass diaphragm control device of claim 17, wherein:
the control includes change processing to change the moving state based on the noise related information.

19. The glass diaphragm control device of claim 18, wherein:
the change processing includes processing to change the overlaying sound based on the moving state information.

20. A non-transitory computer-readable storage medium storing a control program that causes a computer to execute processing comprising:
acquiring noise related information related to noise flowing into a cabin interior of a moving body; and
performing control to generate overlaying sound to be overlaid with the noise from a glass diaphragm of the moving body based on the noise related information.
